(19) United States
(12) Patent Application Publication
(10) Pub. No.: US 2014/0259182 A1
(43) Pub. Date: Sep. 11, 2014

(54) SYSTEM AND METHOD FOR MANAGING MEDIA CONTENT

(71) Applicants: SONY CORPORATION, Tokyo (JP); SONY DADC US INC., Terre-Haute, IN (US)

(72) Inventor: Matthew Mershon, Terre Haute, IN (US)

(73) Assignees: SONY DADC US INC., Terre Haute, IN (US); SONY CORPORATION, Tokyo (JP)

(21) Appl. No.: 13/786,684

(22) Filed: Mar. 6, 2013

(51) Int. Cl. G06F 21/62

(52) U.S. Cl. CPC G06F 21/6209
USPC 726/28

(57) ABSTRACT

Various aspects of a system and method for managing media content may include a media management server communicatively coupled to a media vending device. A portable media storage device may be authenticated in response to a first request to transfer the media content from the media vending device to the portable media storage device. The transferred media content and the portable media storage device are authenticated in response to a second request to render the transferred media content at a media rendering device.

### CROSS-REFERENCE TO RELATED APPLICATIONS/INCORPORATION BY REFERENCE

None.

### FIELD

Various embodiments of the disclosure relate to media content management. More specifically, various embodiments of the disclosure relate to managing distribution of media content in a secure and convenient manner.

### BACKGROUND

Recent developments in digital broadcast media have seen a move towards making higher-resolution formats available for movies, games and similar digital content. For example, with the introduction of 4K digital format for digital media and 4K-compatible televisions, consumers can expect a resolution of about 4096 by 2160 pixels during playback. However, the size of the media content encoded in high-resolution format is excessively large, in the range of about 128 Gigabytes (GB). This makes it difficult to broadcast high-resolution content over digital television networks, through the Internet, or even to record the content on disc media for distribution.

Existing techniques for digital media distribution include on-demand streaming through the Internet and retailing of optical discs, for example. These techniques are vulnerable to piracy since their content-protection mechanisms can be easily cracked for unlawful distribution through file sharing networks. Existing techniques are inadequate to distribute standard and high-resolution media content through available media channels, or to provide convenient, yet secure and controlled access for end-consumers of such content.

Further limitations and disadvantages of conventional and traditional approaches will become apparent to one of skill in the art, through comparison of described systems with some aspects of the present disclosure, as set forth in the remainder of the present application, with reference to the drawings.

### SUMMARY

A system and method are provided for managing media content substantially as shown in, and described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram illustrating a network environment for media content management, in accordance with an embodiment of the disclosure.

FIG. 2 is a block diagram illustrating a computing device for media content management, in accordance with an embodiment of the disclosure.

FIG. 3 is a block diagram illustrating a computing device for media content distribution, in accordance with an embodiment of the disclosure.

FIG. 4 is a flowchart illustrating exemplary steps for media content management, in accordance with an embodiment of the disclosure.

FIG. 5 is a flowchart illustrating exemplary steps for media content management, in accordance with another embodiment of the disclosure.

### DETAILED DESCRIPTION

Various implementations may be found in a system and method for managing media content. Exemplary aspects of a method for managing media content may include a media management server having one or more processors communicatively coupled to a media vending device. In an embodiment, the media management server may be operable to authenticate a portable media storage device in response to a first request to transfer the media content from the media vending device to the portable media storage device. The media management server is further operable to authenticate the transferred media content and the portable media storage device in response to a second request to render the transferred media content at a media rendering device.

The authentication of the portable media storage device is based on a unique device identifier. The unique device identifier is associated with the portable media storage device during registration of a portable media storage device with the media management server. In an example, the unique device identifier may be a set of alphanumeric characters assigned by the media management server based on a predefined numbering scheme or based on the characteristics of the portable media storage device.

In an embodiment, the second request to render the transferred media content is routed to the media management server through an online authentication service. The media management server authenticates the portable media storage device, user account information, and status of the transferred media content in response to the second request.

The authentication of the status of the transferred media content is based on a unique access identifier associated with the transferred media content. The unique access identifier designates a validity period for rendering the transferred media content. The status of the transferred media content indicates either a retail status or a rental status of the transferred media content.

Exemplary aspects of a method for managing media content may include a media vending device having one or more processors communicatively coupled to a media management server. In an embodiment, the media vending device may be operable to request authentication of a portable media storage device from a media management server in response to a first request to transfer media content. The media vending device is further operable to transfer the requested media content to the portable media storage device in response to receiving the authentication of the portable media storage device. The requested media content is transferred from the media vending device to the portable media storage device via a high-speed data transfer connection. The transferred media content is associated with a unique access identifier. The unique access identifier designates a validity period for rendering the transferred media content.

In an embodiment, the media content is received for storage on the media vending device through a secure connection with a content server over a network. The content server may be communicatively coupled to the media management server. In another embodiment, the media content is received for storage on the media vending device through a removable storage rack mounted on and operatively coupled to the media vending device. The media content may be encrypted prior to being stored on the media vending device. In an embodiment, the media content may be encrypted by the content server providing the media content. In another embodiment, the media content may be encrypted by the media management server.

Exemplary aspects of a method for managing media content may include an online authentication server having one or more processors and communicatively coupled to a media management server. In an embodiment, the online authentication server may be operable to receive a request to decrypt the media content from a media rendering device for rendering the media content. The request to decrypt the media content may be received over an on-demand connection established between the media rendering device and the online authentication server. The online authentication server is further operable to route the request from the media rendering device to the media management server. The online authentication server is further operable to permit or deny decryption of the media content at the media rendering device, in response to receiving an authentication response from the media management server.

The media content may be transferred to the media rendering device through a portable media storage device associated with the unique device identifier. In an example, the request to decrypt the media content may be accompanied with the unique device identifier and a unique access identifier.

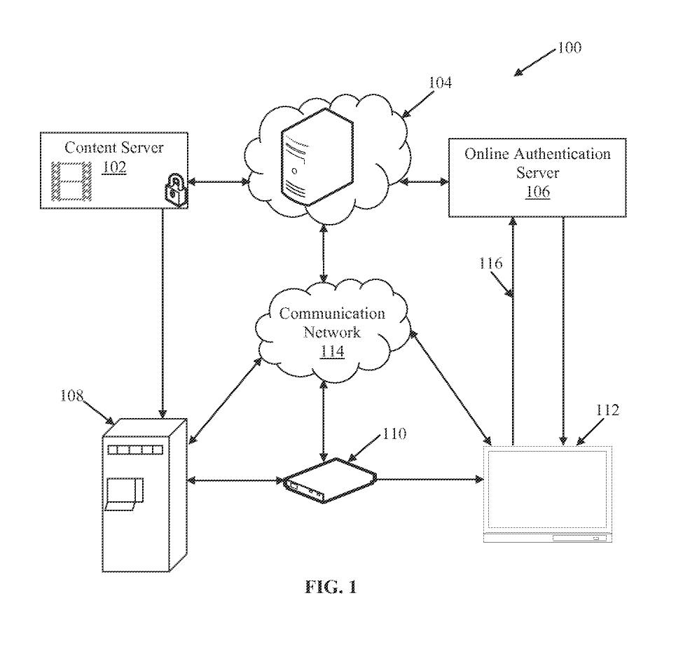

FIG. 1 is a block diagram illustrating a network environment, in accordance with an embodiment of the disclosure. In reference to FIG. 1, there is shown a network environment 100. The network environment 100 may comprise a content server 102, a media management server 104, an online authentication server 106, a media vending device 108, a portable media storage device 110, a media rendering device 112, and a communication network 114.

The content server 102 may comprise suitable logic, circuitry, interfaces, and/or code that may enable communication with the media vending device 108, either directly or via the communication network 114. In an embodiment, the content server 102 may be implemented as part of a server cloud. The content server 102 may be accessed and managed by one or more media production/distribution entities to encrypt the media content, upload the media content, and organize and store the media content according to various predefined criteria. An administrator user associated with the media production/distribution entities may interact with the server 102 directly. In other embodiments, the administrator user may issue commands or instructions indirectly to the content server 102 via the communication network 114.

The media management server 104 may comprise suitable logic, circuitry, interfaces, and/or code that may enable communication with the content server 102, the online authentication server 106, the media vending device 108, and the portable media storage device 110, either directly or via the communication network 114. In an embodiment, the media management server 104 may be implemented as part of a server cloud. The media management server 104 may be configured to implement digital rights management techniques according to various embodiments disclosed herein. The media management server 104 may also be configured to manage registration of one or more portable media storage devices 110 possessed by one or more end users of the network environment 100. The media management server 104 may further be configured to generate and/or store information or metadata associated with the media content, the portable media storage device 110, and a first user account, based on the registration. The media management server 104 may be configured to generate and/or store the information or metadata over the entire lifetime of either the media content or the first user account.

The online authentication server 106 may comprise suitable logic, circuitry, interfaces, and/or code that may enable communication with the media management server 104 and the media rendering device 112, either directly or via the communication network 114. In an embodiment, the online authentication server 106 may be implemented as part of a server cloud. In an embodiment, the online authentication server 106 may be accessed and managed by the media production/distribution entities. In another embodiment, the online authentication server 106 may be accessed and managed by a third party digital rights authentication and licensing entity. The online authentication server 106 may be configured to generate and manage a second user account for each end user of the media content. For example, the online authentication server 106 may be accessed and managed by a media production entity such as Music Unlimited™ (formerly Qriocity) of Sony Corporation or a third-party digital rights authentication and licensing entity such as UltraViolet™.

The media vending device 108 may comprise suitable logic, circuitry, interfaces, and/or code that may enable communication with the content server 102, the media management server 104, and the portable media storage device 110. The media vending device 108 may comprise one or more removable storage racks configured to store the media content. The interfaces of the media vending device 108 may include at least one high-speed data transfer interface, and one or more network interfaces that may enable communication with the content server 102. For example, the high-speed data transfer interface may comprise a universal serial bus (USB) 3.0 interface and/or a Thunderbolt™ interface, or any other type of wired or wireless data interface that is capable of such high data transfer rates. An end user may interact with the media vending device 108 directly via a user interface. The user interface may include a display with a keypad or a touch-screen display. The media vending device 108 may further be configured to generate a graphical user interface. The user interface allows the end user to navigate, control, or issue commands to the graphical user interface.

The portable media storage device 110 may be a portable hard drive having a capacity of about 128 GB and a high-speed data transfer interface. The high-speed data transfer interface may comprise a USB 3.0 interface or a Thunderbolt™ interface, or any other type of wired or wireless data interface that is capable of such high data transfer rates. The portable media storage device 110 may also be a mobile computing device comprising an internal memory or an external flash memory having a high memory capacity of about 128 GB. For example, the portable media storage device 110 may be the Little Big Disk Thunderbolt 9000243 from LaCie™. Notwithstanding, the disclosure may not be so limited and other types of portable media storage device 110 may be used that includes suitable logic, circuitry, interfaces, and/or code that may enable communication with the media management server 104 and the media vending device 108.

The media rendering device 112 may be one or more of a computer and consumer devices or appliances, such as, a network-enabled smart television, a digital media center, a streaming player, a gaming console, an internet-enabled set-top box, and other network-enabled media playback devices capable of playing a range of media content formats, including standard-definition content, high-definition (HD) content, and 4K and 2K content. The media rendering device 112 may comprise suitable logic, circuitry, interfaces, and/or code that may enable communication with the online authentication server 106 and the portable media storage device 110. The interfaces of the media rendering device 112 may comprise at least one high-speed data transfer interface, and one or more network interfaces that may enable communication with the online authentication server 106. For example, the high-speed data transfer interface may comprise a USB 3.0 interface and/or a Thunderbolt™ interface, or any other type of wired or wireless data interface that is capable of such high data transfer rates.

The communication network 114 may include a medium through which the media management server 104 may communicate with the media vending device 108, the portable media storage device 110 and the online authentication server 106 in the network environment 100. Examples of the communication network 114 may include, but are not limited to, the Internet, a Wireless Fidelity (WiFi) network, a Wireless Local Area Network (WLAN), a Local Area Network (LAN), a telephone line (POTS), or a Metropolitan Area Network (MAN). Various devices in the network environment 100 may be operable to connect to the communication network 114, in accordance with various wired and wireless communication protocols, such as, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, and/or Bluetooth (BT) communication protocols.

In operation, the media vending device 108 receives a first request to transfer media content from the media vending device 108 to the portable media storage device 110. In response to the first request to transfer the media content, the media vending device 108 requests authentication of the portable media storage device 110 from the media management server 104. The media management server 104 authenticates the portable media storage device 110 in response to the first request to transfer the media content from the media vending device 108 to the portable media storage device 110. The media vending device 108 transfers the requested media content to the portable media storage device 110 in response to receiving the authentication of the portable media storage device 110 from the media management server 104.

Subsequent to authentication, the online authentication server 106 may receive a second request to decrypt the transferred media content from a media rendering device 112 to render the transferred media content. The second request may be received over an on-demand connection 116 established between the media rendering device 112 and the online authentication server 106. The online authentication server 106 routes the second request from the media rendering device 112 to the media management server 104. In response to the second request to render the transferred media content, the media management server 104 may authenticate the transferred media content and the portable media storage device 110. The online authentication server 106 may permit or deny decryption of the transferred media content at the media rendering device 112 based on the authentication response received from the media management server 104.

In an embodiment, the media vending device 108 may be located in public places in the form of an automated self-service vending kiosk. The media vending device 108 may receive media content for storage from the content server 102. For example, the media rendering device 112 may receive media content though a secure connection with the content server 102 over the communication network 114. In another example, an on-site technician may mount removable storage racks on the media vending device 108. Each storage rack may include suitable interfaces to operatively communicate with one or more processors of the media vending device 108. Each storage rack may contain one or more media content. For example, each storage rack may contain one or more high-definition audio-visual content and/or one or more high-definition graphical gaming content. Alternatively, a single high-definition audio-visual content may be spread across one or more media storage racks. In an embodiment, the high-definition audio-visual content may be encoded in 2K or 4K format. The media content encoded in 4K format provides a horizontal resolution of around 4000 pixels during playback, which is perceptibly higher than the resolution of high-definition content on large screens. The size of the media content in 2K or 4K resolution is usually over 128 Gigabytes.

In an embodiment, the media content is encrypted prior to receiving the media content for storage on the media vending device 108. The media content may be encrypted by the content server 102. Alternatively, the media content may be encrypted by the media management server 104. In an example, the media content is protected using proprietary encryption software and a high pseudo-code encryption. In another example, the media content may also be encapsulated in a protective shell, such as a ZIP or RAR archive file.

In an embodiment, the portable media storage device 110 is required to be registered with the media management server 104 prior to requesting the media content from the media vending device 108. The media management server 104 assigns a unique device identifier to the portable media storage device 110 at the time of registration. Registration of the portable media storage device 110 may also require the user to create first user account with the media management server 104. The user may be required to submit details, such as name, email address, geographical address, and contact numbers for creation of the first user account. In an embodiment, for added security and to mitigate fraud, the media management server 104 may impose a restriction on the number of devices that may be associated with a single user account. During registration, the user may also optionally designate a payment method, such as debit/credit card information, for future transactions with the media management server 104. Additionally, the user may also set up an electronic wallet (e-wallet) with the first user account to establish a credit account with the media management server 104.

In an embodiment, the user may employ a high-speed data transfer interface to connect a registered portable media storage device 110 to the media vending device 108. The user navigates the GUI of the media vending device 108 and selects one or more media content for download. In response to the selection of the media content, the media vending device 108 may communicate with the media management server 104 to request authentication of the registered portable media storage device 110 from the media management server 104. In an embodiment, the media vending device 108 may communicate with the media management server 104 to request authentication of the registered portable media storage device 110 when the user connects the registered portable media storage device 110 to the media vending device 108. The request to authenticate the registered portable media storage device 110 may be accompanied with the unique device identifier of the registered portable media storage device 110. Examples of the unique device identifier include alphanumeric characters based on a predefined numbering scheme or alphanumeric characters based on the characteristics of the portable media storage device 110. In another example, the unique device identifier is based on a username-password combination associated with the first user account. The media management server 104 may authenticate the portable media storage device 110 based on the unique device identifier. The authentication of registered portable media storage device 110 at the time of requesting the media content provides additional security by prohibiting arbitrary devices from accessing the media vending device 108. In case the media management server 104 fails to recognize the portable media storage device 110 based on the unique device identifier, the request to download the media content is denied. If the authentication is successful, the user may need to login to the first user account by providing a username and password associated with the first user account.

After the login, the media vending device 108 may display the user account information on the graphical user interface (GUI). The user account information may include user demographic and location details, purchase history, and credit balance in the credit account or e-wallet of the user, among other things. At the time of selection of the media content, the user may also indicate whether the user wishes to purchase the media content on retail basis or rental basis. As used herein, media content purchased on retail basis allows the user to own a copy of the media content for lifetime. This allows the user to play the media content at any time and any place after decryption through the online authentication server 106. After the purchase is made, the requested media content is transferred from the media vending device 108 to the portable media storage device 110, via a high-speed data transfer connection through the high-speed data interface. The data transfer rate provided by the USB™ 3.0 interface is approximately 5 GBps. The data transfer rate provided by the Thunderbolt™ interface is approximately 10 GBps.

In an embodiment, the media vending device 108 may include a provision for payment, such as a slot for a card scanner and a keypad to offer debit/credit payment at the site of transaction. To complete the transaction, the media vending device 108 may deduct a required amount from the credit account or e-wallet of the user, or from the designated bank account, based on the debit/credit card information. For example, the media vending device 108 may debit a first amount for a retail purchase of the media content. The media vending device 108 may debit a second amount different from the first amount for a rental transaction.

In an embodiment, the media content transferred from media vending device 108 to the portable media storage device 110 is associated with a unique access identifier at the time of transfer. The unique access identifier designates a validity period for which to render the transferred media content. The unique access identifier may be metadata associated with the transferred media content.

In an embodiment, the user of the portable media storage device 110 may connect the portable media storage device 110 to the media rendering device 112 via the high-speed data transfer interface. The media rendering device 112 may be capable of recognizing the connection with the portable media storage device 110 and scan the memory content of the portable media storage device 110. The media rendering device 112 may be configured to present a list of stored media content on the display screen of the media rendering device 112, organized based on types of the media content.

In an embodiment, the user may be required to register with the online authentication server 106 prior to requesting the online authentication server 106 to decrypt the media content on the media rendering device 112. The registration with the online authentication server 106 may include creating a second user account with the online authentication server 106.

In an embodiment, the online authentication server 106 may provide client application software to the media rendering device 112 at the time of registration. To complete the registration process, the user may be required to download and install the client application on the media rendering device 112. The installation of the client application makes the media rendering device 112 compatible with the service provided by the online authentication server 106. The installed client application may be operable to recognize the media content on the portable media storage device 110 and access the online authentication server 106. In an embodiment, the installation of the client application may establish a dedicated television channel if the media rendering device 112 is a 2K- or 4K-supported smart television or an Internet enabled set-top box.

In an embodiment, to playback the media content on the media rendering device 112, the user may be required to tune to the dedicated television channel, log in to the second user account, and indicate the selection of the transferred media content. In response to the selection of the transferred media content, the client application communicates with the online authentication server 106 to establish an on-demand connection 116 between media rendering device 112 and the online authentication server 106. The online authentication server 106 provides a proprietary channel to establish the on-demand connection 116 between the media rendering device 112 and the online authentication service 106. In an example, the proprietary channel is based on a service channel provided by Qriocity™ or UltraViolet™.

In an embodiment, the online authentication server 106 receives a request to decrypt the transferred media content for playback from the media rendering device 112. The request for decryption may be carried out via the on-demand connection 116 established between the media rendering device 112 and the online authentication server 106. The request to decrypt the transferred media content may be accompanied with the unique device identifier and the unique access identifier, and may optionally include the login credentials associated with the second user account. The online authentication server 106 may route the request from the media rendering device 112 to the media management server 104.

The media management server 104 may authenticate the transferred media content and the portable media storage device 110 in response to the request to render the transferred media content at the media rendering device 112. In an embodiment, the media management server 104 may be further operable to validate user account information and status of the transferred media content, in response to the request to render the transferred media content. The media management server 104 may authenticate status of the transferred media content based on the unique access identifier associated with the transferred media content. The status of the transferred media content may indicate either retail status or rental status of the transferred media content. In case of rental status, the media management server 104 may determine whether the validity period for rendering the media content has expired or not. The media management server 104 may communicate an authentication response to the online authentication server 106. The authentication response may indicate authentication of the media content for playback and the authentication of the portable media storage device 110, based on the unique device identifier. The media management server 104 may not validate the playback of the media content if the validity period for rendering rented media content has expired.

In response to receiving the authentication response from the media management server 104, the online authentication server 106 may permit or deny decryption of the transferred media content. In an embodiment, the decryption of the transferred media content may comprise removing the protective shell encapsulating the media content, decrypting the encrypted media content using proprietary encryption/decryption software and a high pseudo-code encryption algorithm. After decryption, the media rendering device 112 plays the media content based on the encoding format of the media content.

For purposes of description, the first user account is described with reference to the registration of the portable media storage device 110 with the media management server 102, while the second user account is described with reference to the registration of the user with the online authentication server 106. However, in an embodiment, the first user account and the second user account of the user may be a single user account based on single login credentials. For example, the user may register the portable media storage device 110 with an existing user account of the user with the online authentication server 106. The media management server 104 and the online authentication server 106 may maintain a single user account with multiple instances of registration information for both the registration of the portable media storage device 110 and the user registration with the online authentication server 106, such as Qriocity™ or UltraViolet™. Nonetheless, the user may be required to submit their login credentials both at the time of requesting the media content at the media vending device 108 and at the time of requesting the decryption and/or rendering of the media content through the media rendering device 112.

In another embodiment, the first user account and the second user account of the user may be a single user account, but may require the user to submit different login credentials at the time of requesting the media content and at the time of requesting the decryption and/or rendering of the media content. In another embodiment, the first user account and the second user account may be different user accounts, and may be maintained separately by the media management server 104 and the online authentication server 106, respectively.

In an embodiment, the user is allowed to access the media vending device 108 and re-transfer the purchased media content to a different portable media storage device if the original portable media storage device 110 used to download the media content becomes corrupt. The user can revisit and access the media vending device 108 with another registered portable media storage device 110. The user can submit login credentials at the media vending device 108 to access the purchase history, and re-transfer the purchased media content to the portable media storage device 110.

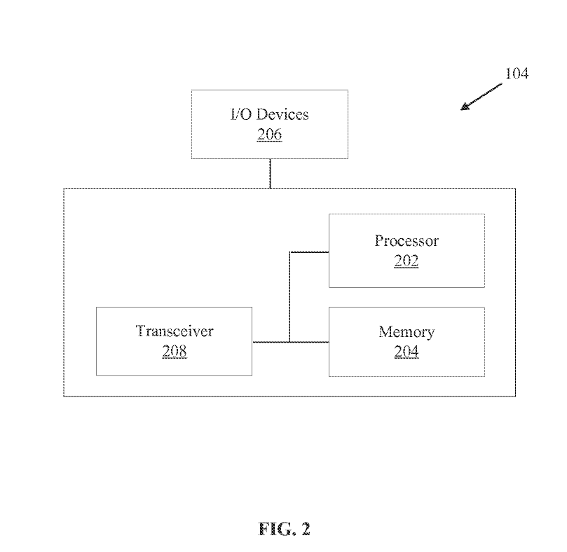

FIG. 2 is a block diagram illustrating a computing device for media content management, in accordance with an embodiment of the disclosure. FIG. 2 is explained in conjunction with elements from FIG. 1. In reference to FIG. 2, there is shown the media management server 104. The media management server 104 may comprise a processor 202, a memory 204, Input-Output (I/O) devices 206, and a transceiver 208.

The processor 202 may be communicatively coupled to the memory 204, and the I/O devices 206. Further, the transceiver 208 may be communicatively coupled to the processor 202, the memory 204, and the I/O devices 206.

The processor 202 may comprise suitable logic, circuitry, interfaces, and/or code that may be operable to execute a set of instructions stored in the memory 204. The processor 202 may be implemented based on a number of processor technologies known in the art. Examples of processor 202 may be an X86-based processor, a RISC processor, an ASIC processor, a CISC processor, or any other processor.

The memory 204 may comprise suitable logic, circuitry, interfaces, and/or code that may be operable to store the received set of instructions. The memory 204 may be implemented based on, but not limited to, a Random Access Memory (RAM), a Read-Only Memory (ROM), a Hard Disk Drive (HDD), a storage server and/or a secure digital (SD) card.

The I/O devices 206 may comprise various input and output devices operably connected to the processor 202. Examples of input devices include, but are not limited to, a keyboard, a mouse, a joystick, a touch screen, a microphone, a camera, a motion sensor, a light sensor, and/or a docking station. Examples of output devices include, but are not limited to, a display and a speaker.

The transceiver 208 may comprise suitable logic, circuitry, interfaces, and/or code that may be operable to communicate with the media vending device 108, the online authentication server 106, the portable media storage device 110, and the content server 102 via different communication interfaces. The transceiver 208 may implement known technologies for supporting wired or wireless communication with the communication network 114.

In operation, the processor 202 may be operable to authenticate a portable media storage device 110 in response to a first request to transfer the media content from the media vending device 108 to the portable media storage device 110. The processor 202 may be further operable to authenticate the transferred media content and the portable media storage device 110 in response to a second request to render the transferred media content at a media rendering device 112.

In an embodiment, the processor 202 is operable to authenticate the portable media storage device 110, based on a unique device identifier. The unique device identifier is associated with the portable media storage device 110 during a registration of the portable media storage device 110 with the media management server 104.

In an embodiment, the second request to render the transferred media content is routed to the media management server 104 through an online authentication service. In an example, the online authentication service is based on the content authentication and licensing service of a media production entity or a third party. In response to the second request, the processor 202 is operable to authenticate the portable media storage device 110, user account information, and a status of the transferred media content.

In an embodiment, the processor 202 is operable to authenticate the status of the transferred media content, based on a unique access identifier associated with the transferred media content. The unique access identifier designates a validity period for rendering the transferred media content. The status of the transferred media content indicates either a retail status or a rental status of the transferred media content.

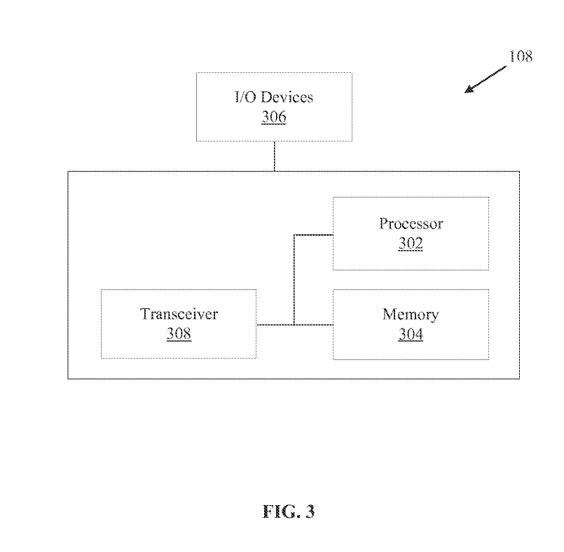

FIG. 3 is a block diagram illustrating a computing device for media content distribution, in accordance with an embodiment of the disclosure. FIG. 3 is explained in conjunction with elements from FIG. 1. In reference to FIG. 3, there is shown the media vending device 108. The media vending device 108 may comprise a processor 302, a memory 304, Input-Output (I/O) devices 306, and a transceiver 308.

The processor 302 may be communicatively coupled to the memory 304, and the I/O devices 306. Further, the transceiver 308 may be communicatively coupled to the processor 302, the memory 304, and the I/O devices 306.

The processor 302 may comprise suitable logic, circuitry, interfaces, and/or code that may be operable to execute a set of instructions stored in the memory 304. The processor 302 may be implemented based on a number of processor technologies known in the art. Examples of processor 302 may be an X86-based processor, a RISC processor, an ASIC processor, a CISC processor, or any other processor.

The memory 304 may comprise suitable logic, circuitry, interfaces, and/or code that may be operable to store the received set of instructions. The memory 304 may be implemented based on, but not limited to, a Random Access Memory (RAM), a Read-Only Memory (ROM), a Hard Disk Drive (HDD), a storage server and/or a secure digital (SD) card.

The I/O devices 306 may comprise various input and output devices operably connected to the processor 302. Examples of input devices include, but are not limited to, a keyboard, a mouse, a joystick, a touch screen, a microphone, a camera, a motion sensor, a light sensor, and/or a docking station. Examples of output devices include, but are not limited to, a display and a speaker.

The transceiver 308 may comprise suitable logic, circuitry, interfaces, and/or code that may be operable to communicate via various communication interfaces with the content server 102, the media management server 104, and the portable media storage device 110. The transceiver 308 may implement known technologies for supporting wired or wireless communication with the communication network 114.

In operation, the processor 302 may be operable to request authentication of the portable media storage device 110 from the media management server 104, in response to a first request to transfer the media content to the portable media storage device 110. The processor 302 may be operable to transfer the requested media content to the portable media storage device 110 in response to receiving the authentication of the portable media storage device 110. The processor 302 may be operable to associate a unique access identifier with the transferred media content. The unique access identifier may designate a validity period for rendering the transferred media content.

In an embodiment, the processor 302 is operable to transfer the requested media content from the media vending device 108 to the portable media storage device 110, via a high-speed data transfer connection. The high-speed data transfer connection may be accomplished using a USB 3.0 interface or the Thunderbolt™ interface of the media vending device 108.

In an embodiment, the processor 302 is operable to receive the media content for storage on the media vending device 108 through a secure connection with the content server 102 over the network 114. In another embodiment, the processor 302 is operable to receive the media content for storage on the media vending device 108 through a removable storage rack mounted on and operatively coupled to the media vending device 108.

In an embodiment, the media content may be encrypted prior to receiving the media content for storage on the media vending device 108. The media content may be encrypted by the content server 102. Alternatively, the media content may be encrypted by the media management server 104.

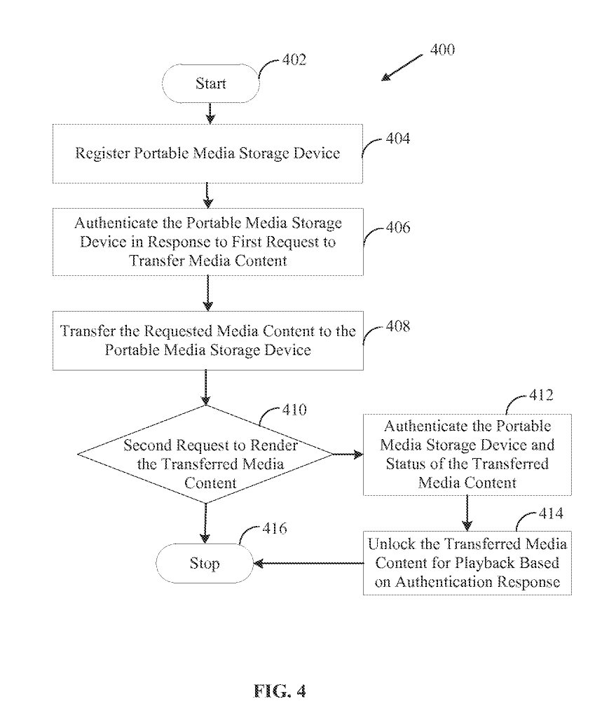

FIG. 4 is a flowchart 400 illustrating exemplary steps for media content management, in accordance with an embodiment of the disclosure. FIG. 4 will be described in conjunction with elements of FIG. 1. The method 400 may be implemented in a network comprising an online authentication server 106, a media vending device 108, and a portable media storage device 110 communicatively coupled to a media management server 104.

The method 400 begins at step 402. At step 404, the portable media storage device 110 is registered with the media management server 104. The registration of the portable media storage device 110 may require the user of the portable media storage device 100 to create a first user account with the media management server 104. The media management server 104 may assign a unique device identifier to the portable media storage device 110 at the time of registration.

At step 406, in response to a first request to transfer media content from the media vending device 108 to the portable media storage device 110, the media management server 104 may be operable to authenticate the portable media storage device 110. The request to transfer the media content from the media vending device 108 to the portable media storage device 110 may be accompanied with the unique device identifier of the portable media storage device 110. The media management server 104 may authenticate the portable media storage device 110, based on the unique device identifier. The media management server 104 may also authenticate the account information of the first user account.

At step 408, the media vending device 108 may be operable to transfer the requested media content to the portable media storage device 110, based on the authentication response of the media management server 104. The media vending device 108 may associate a unique access identifier with the media content at the time of transfer.

At step 410, the online authentication server 106 may receive a second request to render the transferred media content on a media rendering device 112. The online authentication server 106 may receive the second request via an on-demand connection 116 established between the media rendering device 112 and the online authentication server 106. The online authentication server 106 is further operable to provide a proprietary channel that establishes the on-demand connection 116 between the media rendering device 112 and the online authentication server 106. The on-demand connection 116 may enable access to the online authentication server 106 through the media rendering device 112. In response to receiving the second request, the online authentication server 106 may route the second request, along with the unique device identifier and the unique access identifier, to the media management server 104.

At step 412, the media management server 104 may be operable to authenticate the portable media storage device 110 and the status of the media content, in response to the second request to render the media content. The media management server 104 may authenticate the portable media storage device 110, based on the unique device identifier. The media management server 104 may authenticate the status of the media content based on the unique access identifier. The media management server 104 may also be operable to authenticate the user account information in response to the second request to render the media content. The media management server 104 may send an authentication response to the online authentication server 106, in response to the second request.

At step 414, the online authentication server 106 may be operable to unlock the transferred media content based on the authentication response to make the media content available for playback. The unlocking of the transferred media content may comprise removing a protective shell encapsulating the media content and/or decryption of the media content. After the decryption, the media rendering device 112 plays the media content, based on the encoding format of the media content. At step 416, the method 400 ends.

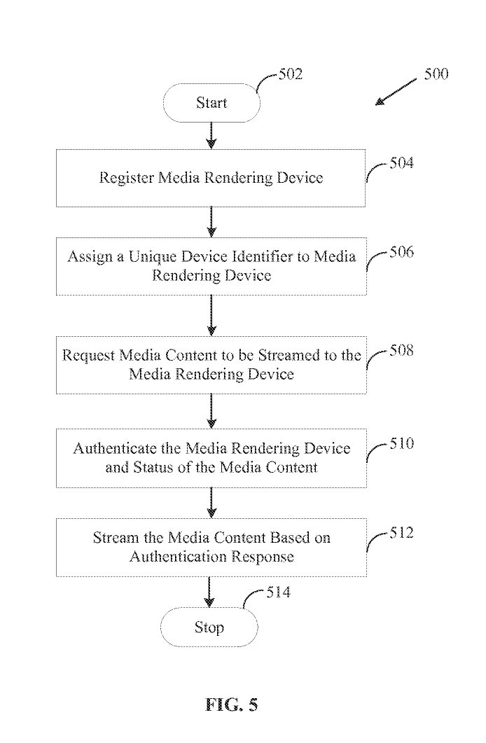

FIG. 5 is a flowchart illustrating exemplary steps for media content management, in accordance with another embodiment of the disclosure. FIG. 5 will be described in conjunction with elements of FIG. 1. The method 500 may be implemented in a network comprising an online authentication server 106 communicatively coupled to a media management server 104.

The method 500 begins at step 502. At step 504, the media rendering device 112 of the user is registered with the media management server 104. The registration of the media rendering device 112 may require the user of the media rendering device 112 to create a first user account with the media management server 104. At step 506, the media management server 104 may assign a unique device identifier to media rendering device 112 at the time of registration.

At step 508, the user may request media content to be streamed to the media rendering device 112 by accessing the online authentication server 106 through the media rendering device 112. The user may select media content from a list of available media content displayed to the user on the media rendering device 112. For example, the media content may include standard-definition content, high-definition content, or other types of media content that may be streamed to the media rendering device 112 in a reasonable amount of time. The online authentication server 106 may receive the request over an on-demand connection 116 established between the media rendering device 112 and the online authentication server 106. In response to receiving the second request, the online authentication server 106 may route the second request, along with the unique device identifier, to the media management server 104.

At step 510, the media management server 104 may be operable to authenticate the media rendering device 112 and status of the media content, in response to the request to stream media content. The media management server 104 may also be operable to authenticate the user account information in response to the request to stream the media content. The media management server 104 may send an authentication response to the online authentication server 106 based on the authentication.

At step 512, the online authentication server 106 may be operable to stream the selected media content based on the authentication response. The media rendering device 112 plays the streaming media content, based on the encoding format of the streaming media content. At step 514, the method 500 ends.

In accordance with another embodiment of the disclosure, a method and system for managing media content may comprise a media management server 104 and an online authentication server 106. The media management server 104 may be communicatively coupled to a media vending device 108. The media management server 104 may comprise one or more processors, for example, processor 202 (FIG. 2). The processor 202 may be operable to authenticate a portable media storage device 110 in response to a first request to transfer media content from the media vending device 108 to the portable media storage device 110. The processor 202 may be operable to authenticate the transferred media content and the portable media storage device 110, in response to a second request to render the transferred media content at a media rendering device 112. The online authentication server 106 may comprise one or more processors, for example, processor 302 (FIG. 3). The processor 302 may be operable to route the second request from the media rendering device 112 to the media management server 104. The online authentication server 106 may receive the second request via an on-demand connection 116 established between the media rendering device 112 and the online authentication server 106.

In an embodiment, the online authentication server 106 is further operable to provide a proprietary channel that establishes the on-demand connection 116 between the media rendering device 112 and the online authentication service 106. The proprietary channel enables access to the online authentication server 106 through the media rendering device 112. The proprietary channel may be based on a client application installed on the media rendering device 112.

In an embodiment, the media management server 104 is further operable to authenticate the user account information and status of the transferred media content, in response to the second request to render the transferred media content. In an embodiment, the media management server 104 is operable to authenticate the status of the transferred media content based on a unique access identifier associated with the transferred media content. The status of the transferred media content indicates either a retail status or a rental status of the transferred media content.

In an embodiment, the media management server 104 is operable to authenticate the portable media storage device 110, based on a unique device identifier associated with the portable media storage 110. The unique device identifier may be associated with the portable media storage device 110 during a registration of the portable media storage device 110 with the media management server 104.

In an embodiment, in response to receiving an authentication response from the media management server 104, the online authentication server 106 unlocks the transferred media content for rendering based on the authentication of the portable media storage device 110 and the status of the transferred media content. The online authentication server 106 may unlock the transferred media content by decrypting the media content.

Other embodiments of the disclosure may provide a non-transitory computer readable medium, and/or storage medium, and/or a non-transitory machine-readable medium and/or storage medium. Having applicable mediums stored thereon, a machine code and/or a computer program having at least one code section executable by a machine and/or a computer, may thereby cause the machine and/or computer to perform the steps comprising managing media content in a media management server 104. A portable media storage device 110 is authenticated in response to a first request to transfer the media content from a media vending device 108 to the portable media storage device 110. The transferred media content and the portable media storage device 110 are authenticated in response to a second request to render the transferred media content at a media rendering device 112.

Accordingly, the present disclosure may be realized in hardware, or a combination of hardware and software. The present disclosure may be realized in a centralized fashion, in at least one computer system, or in a distributed fashion, where different elements may be spread across several interconnected computer systems. Any kind of computer system or other apparatus adapted for carrying out the methods described herein may be suited. A combination of hardware and software may be a general-purpose computer system with a computer program that, when being loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features enabling the implementation of the methods described herein, and which when loaded in a computer system is able to carry out these methods. Computer program, in the present context, means any expression, in any language, code or notation, of a set of instructions intended to cause a system having an information processing capability to perform a particular function either directly, or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A method for managing media content, comprising:
in a media management server communicatively coupled to a media vending device:
authenticating a portable media storage device in response to a first request to transfer said media content from said media vending device to said portable media storage device; and
authenticating said transferred media content and said portable media storage device in response to a second request to render said transferred media content at a media rendering device.

2. The method of claim 1, wherein said second request to render said transferred media content is routed to said media management server through an online authentication service, wherein said media management server authenticates said portable media storage device, user account information, and a status of said transferred media content.

3. The method of claim 2, wherein said authentication of said status of said transferred media content is based on a unique access identifier associated with said transferred media content, wherein said unique access identifier designates a validity period for rendering said transferred media content, wherein said status of said transferred media content indicates one of a retail status and a rental status of said transferred media content.

4. The method of claim 2, wherein said authentication of said portable media storage device is based on a unique device identifier, wherein said unique device identifier is associated with said portable media storage device during a registration of said portable media storage device with said media management server.

5. A method for managing media content, comprising:
in a media vending device communicatively coupled to a media management server:
requesting authentication of a portable media storage device from a media management server in response to a first request to transfer said media content; and
transferring said requested media content to said portable media storage device in response to receiving said authentication of said portable media storage device, wherein said transferred media content is associated with a unique access identifier.

6. The method of claim 5, further comprising receiving said media content for storage on said media vending device via one or both of:
a secure connection with a content server over a network, said content server communicatively coupled to a media management server; and
a removable storage rack mounted on and operatively coupled to said media vending device.

7. The method of claim 6, wherein said media content is encrypted prior to being stored on said media vending device.

8. The method of claim 6, wherein said media content is encrypted by said content server providing said media content.

9. The method of claim 6, wherein said media content is encrypted by said media management server.

10. The method of claim 5, wherein said unique access identifier designates a validity period for rendering said transferred media content.

11. The method of claim 5, wherein said requested media content is transferred from said media vending device to said portable media storage device via a high-speed data transfer connection.

12. The method of claim 5, wherein said transferred media content is authenticated by said media management server based on said unique access identifier, in response to a second request to render said transferred media content at a media rendering device.

13. A system for managing media content, comprising:
a media management server communicatively coupled to a media vending device, said media management server comprising one or more processors operable to:
authenticate a portable media storage device in response to a first request to transfer media content from said media vending device to said portable media storage device;
authenticate said transferred media content and said portable media storage device in response to a second request to render said transferred media content at a media rendering device; and
an online authentication server communicatively coupled to said media management server, said online authentication server operable to route said second request from said media rendering device to said media management server, wherein said second request is received by said online authentication server via an on-demand connection established between said media rendering device and said online authentication server.

14. The system of claim 13, wherein said online authentication server is further operable to provide a proprietary channel that establishes said on-demand connection between said media rendering device and said online authentication service to enable access to said online authentication service through said media rendering device, wherein said proprietary channel is based on a client application installed on said media rendering device.

15. The system of claim 13, wherein said media management server is further operable to authenticate said portable media storage device, user account information, and a status of said transferred media content in response to said second request to render said transferred media content.

16. The system of claim 13, wherein said media management server is operable to authenticate said status of said transferred media content based on a unique access identifier associated with said transferred media content, wherein said status of said transferred media content indicates one of a retail status and a rental status of said transferred media content.

17. The system of claim 13, wherein said media management server is operable to authenticate said portable media storage device based on a unique device identifier, wherein said unique device identifier is associated with said portable media storage device during a registration of said portable media storage device with said media management server.

18. The system of claim 13, wherein said online authentication server is operable to unlock said transferred media content for rendering based on said authentication of said portable media storage device and a status of said transferred media content by said media management server.

19. The system of claim 18, wherein said online authentication server unlocks said transferred media content by decrypting said media content.

20. The system of claim 13, wherein said media content is one of 4K content and/or 2K content.

21. A method for managing media content, comprising:
in an online authentication server communicatively coupled to a media management server:
receiving a request to decrypt said media content from a media rendering device for rendering said media content, said request received over an on-demand connection established between said media rendering device and said online authentication server;
routing said request from said media rendering device to said media management server; and
authenticating decryption of said media content at said media rendering device in response to receiving a response from said media management server.

22. The method of claim 21, wherein said media content is transferred to said media rendering device through a portable media storage device associated with a unique device identifier, wherein said portable media storage device is associated with said unique device identifier during a registration of said portable media storage device with said media management server.
